(19) United States
(12) Patent Application Publication
(10) Pub. No.: US 2011/0259223 A1
(43) Pub. Date: Oct. 27, 2011

(54) SOFT LITHOGRAPHY DEVICE AND PROCESS

(75) Inventors: Jean-Christophe Cau, Toulouse (FR); Ludovic Lafforgue, Saint-Gaudens (FR)

(73) Assignee: INNOPSYS S.A., Carbonne (FR)

(21) Appl. No.: 13/042,974

(22) Filed: Mar. 8, 2011

(30) Foreign Application Priority Data
Apr. 26, 2010 (FR) FR 10 53176

(51) Int. Cl. B41N 1/22

(52) U.S. Cl. 101/453

(57) ABSTRACT

The present technology relates to a device and process for soft lithography by micro-contact printing using a flexible stamp to make a structured deposit of molecules on a substrate such as a glass plate intended for microscopic observation. It enables a simple and effective control of the application pressure of a stamp or a macro-stamp for soft lithography on the surface of a substrate and makes the automation of the soft lithography process easier by integrating the automatic stamp change into it. Micro-contact printing stamps of the invention preferably comprise a flexible stamp including a layer containing soft ferromagnetic particles. Micro-contact printing apparatuses of the invention preferably comprise a magnetic field generator capable of applying uniform pressure to contact a stamp against a substrate, and further are preferably capable of holding the stamp, contacting the stamp with an inking tank, and changing the stamp.

### CROSS REFERENCE TO RELATED APPLICATIONS

This application claims priority under 35 U.S.C. §119(a) to French patent application FR 1053176, filed Apr. 26, 2010.

### BACKGROUND OF THE INVENTION

The presently described technology generally relates to a device and process for soft lithography by micro-contact printing (μCP), and more particularly to using a flexible stamp to deposit molecules on a substrate (such as a glass plate). In particular, the disclosed technology concerns an advantageous method and apparatus for applying uniform pressure on a lithography stamp, and for enabling improved automatic substitution of different stamps. It has been surprisingly discovered that by including a soft ferromagnetic material or particles in a flexible stamp, a magnetic field can be used to apply a uniform pressure on the stamp. It has also been discovered that, for example, a stamp can be made such that it can be magnetized or de-magnetized, so that the stamp can be easily manipulated or moved by a second magnetic field, without the necessity of seals, mechanical interaction, or fluid. Therefore, it is possible to easily change stamps using the disclosed technology to, for at least one instance, use stamps with differing flexibility and/or complex shapes.

Soft lithography is used as a method for depositing a pattern of biological molecules (for example, proteins, nucleic acids, or lipids) on a substrate. Soft lithography can be used, for example, to prepare a biological material for microscopic analysis, or for preparing biochips, biosensors, cell cultures, or similar applications. In particular, it is known to use a flexible thermoplastic or elastomer stamp in soft lithography, wherein molecules are “inked” on the stamp, and transferred to a substrate by pressing the stamp to the substrate. This soft lithography method is known as “micro-contact printing” or “μCP.” By using a stamp with a structured pattern, molecules can be transferred to the substrate in the same pattern. Micro-contact printing is desirable for transferring biological materials, such as proteins, to a substrate, because it is direct, fast, and gentle.

One such micro-contact printing process is described, for example, in the present inventors' co-pending U.S. application Ser. No. 12/206,146 (U.S. Pub. App. No. U.S. 2009/0087019), which is incorporated herein by reference. In that application, the inventors disclose a method for the simultaneous deposit of multiple patterns of molecules (such as, for example, a single stamp that can produce multiple biochips). Other micro-contact printing devices and methods are disclosed in U.S. Pub. App. No. 2007/0098899 to Wessels, et al., and U.S. Pub. App. No. 2006/0174789 to Liebau, et al.

It has been further discovered that the quality of the transfer of molecules by contact is strongly influenced by the uniformity of the pressure of the stamp on the substrate during the micro-contact printing operation, and by the capacity of the stamp to conform to the surface of the substrate. Therefore, it is desirable to use a flexible stamp for micro-contact printing, so that the stamp can conform to the surface of a substrate. However, it is difficult to uniformly flatten a very flexible stamp, particularly by using mechanical force on the stamp. Prior art methods typically have attempted to solve this problem by using a flattening device that applies gas pressure or vacuum to a stamp to contact it to a substrate. However, such methods require a seal between the stamp and flattening device. Such a seal, and the resulting complexity in the method and apparatus, makes it difficult to automatically change the stamp, and consequently, makes it difficult to fully automate a process or apparatus for micro-contact printing.

Therefore, the present inventors have invented a soft lithography device having an automated stamp changing capacity, while also providing a high transfer quality by application of a uniform and controlled flattening pressure of the stamp on the substrate during micro-contact printing.

### SUMMARY OF THE INVENTION

At least one aspect of the present technology concerns an apparatus for soft lithography including a flexible stamp having a contact surface capable of depositing a substance onto a substrate in a pattern, wherein the flexible stamp contains ferromagnetic material. Preferably, the contact surface is disposed on a first elastomer layer that does not include ferromagnetic material, while a second elastomer layer is provided opposite the contact surface, which does include ferromagnetic material. Also preferably, the second elastomer layer comprises between 50% to 95% by weight of soft ferromagnetic material, for example, in the form of ferromagnetic particles dispersed in the elastomer layer. The elastomer layers may be made of, for example, polydimethylsiloxane (PDMS), although other suitable materials may be used.

In other aspects of the present technology, the soft lithography apparatus also includes a first magnetic field generator capable of moving and positioning the flexible stamp. The first magnetic field generator may be, for instance, an electromagnet (e.g., a solenoid or solenoid around a magnet) that is capable of generating a magnetic field when electrical current is applied to it. The first magnetic field generator is preferably capable of being turned on and off and/or is preferably capable of being adjusted to vary the strength of the magnetic field. The first magnetic field generator can also be disposed on one or more tracks on which the first magnetic field generator can be moved. In certain embodiments of the present technology, the tracks can be provided as three perpendicular axes. The first magnetic field generator can therefore be capable of grasping, holding, or lifting the flexible stamp and moving it to a desired position. For example, the first magnetic field may be configured to move the flexible stamp between an inking tank containing the substance to be deposited on the substrate, and one or more substrate holders.

In yet other aspects of the present technology, the soft lithography apparatus also includes a second magnetic field generator positioned near the substrate on which the substance is to be deposited. Preferably, the second magnetic field generator is positioned on the side of the substrate opposite where the flexible stamp is contacted to the substrate, and is usually below the substrate. The second magnetic field generator is capable of applying a pressure to the flexible stamp against the substrate, preferably a substantially uniform pressure. The second magnetic field generator may be a permanent magnet or may be an electromagnet such as a solenoid or a solenoid around a magnet. In at least some embodiments using a permanent magnet, the pressure of the flexible stamp against the substrate may be controllable or adjustable by varying the distance between the magnet and the flexible stamp. In at least some embodiments using an electromagnet, the pressure of the flexible stamp against the substrate may be controllable and/or variable by activating or de-activating or varying the current or voltage applied to the electromagnet.

In further aspects of the present technology, the apparatus can also include an electrode between the second magnetic field generator and the substrate, and the apparatus may be capable of measuring the electric capacitance between the electrode and the second elastomer layer of the flexible stamp containing a ferromagnetic material. The apparatus may therefore provide information indicating the strength of the magnetic field applied to press the flexible stamp against the substrate and/or may provide information indicating the pressure by which the flexible stamp is pressed against the substrate.

Finally, another aspect of the present technology includes a micro-contact printing process. The process can include (a) providing a flexible stamp having a contact surface with a pattern, where at least one layer of the flexible stamp contains ferromagnetic material, (b) exposing the contact surface of the flexible stamp with a substance so that at least some of the substance is retained on the contact surface, and (c) applying a magnetic field on the opposite side of the substrate from the flexible stamp, such that the magnetic field applies a pressure to press the contact surface of the stamp against the substrate, and at least some of the substance is transferred onto the substrate in the pattern. Preferably, the pressure applied by the magnetic field generator to press the flexible stamp against the substrate is substantially uniform. Also, the process can further include steps such as (d) providing an inking tank containing the substance to be applied to the substrate, and (e) moving the flexible stamp between the inking tank and the substrate by using a second magnetic field generator that is movable, for example.

Other aspects of the presently disclosed technology will be apparent from this disclosure and the accompanying drawings.

### BRIEF DESCRIPTION OF THE DRAWINGS

FIG. 1 is an exemplary flexible stamp for use in soft lithography micro-contact printing, in cross-sectional view.

FIG. 2 is an exemplary flexible macro-stamp for use in soft lithography micro-contact printing, in cross-sectional view, wherein the macro-stamp comprises one or more smaller stamps with different patterns.

FIG. 3 is an exemplary micro-contact printing apparatus in cross-sectional view, showing the entire stamp, substrate, and magnetic field generators for moving the stamp and applying pressure to the stamp against the substrate.

FIG. 4 is a top view in perspective of an automated device for soft lithography micro-contact printing.

FIG. 5 is a right perspective view in greater detail of the device of FIG. 4, showing a flexible stamp and a magnetic field generator for grasping or lifting the flexible stamp.

FIG. 6a is a cross-sectional view of a flexible stamp being lowered to a substrate.

FIG. 6b is a cross-sectional view of a flexible stamp being pressed against a substrate with desirable pressure.

FIG. 6b is a cross-sectional view of a flexible stamp being pressed against a substrate with undesirably excessive pressure.

FIG. 7 is a graph showing electrical capacitance between the flexible stamp containing ferromagnetic material and an electrode placed on the opposite side of the substrate, as a function of the pressure applied to press the flexible stamp against the substrate.

FIG. 8 is a diagram of an exemplary embodiment comprising a light source and light sensor for determining optimum contact of a stamp against a substrate.

FIG. 9 is a graph of magnetic force versus applied voltage for several exemplary magnets and an exemplary stamp.

FIG. 10 is a graph of magnetic force versus distance between an exemplary magnetic stamp and different exemplary magnetic field generators.

FIG. 11 is a graph of capacitance versus distance between an exemplary magnetic stamp and various exemplary magnetic field generators.

### DETAILED DESCRIPTION OF THE PREFERRED EMBODIMENTS

The invention will now be described more fully hereinafter with reference to the accompanying drawings, in which one or more embodiments are shown. This invention may, however, be embodied in many different forms and should not be construed as limited to the embodiments described herein. Rather, these embodiments are examples of the invention, which has the full scope indicated by the language of the claims. Like numbers refer to like elements throughout.

In the following embodiments, exemplary micro-contact printing stamps, micro-contact printing apparatuses, and methods of manufacture and use are described. The micro-contact printing stamp and printing apparatus may be capable of uniform contact pressure against a substrate, and may be capable of automated substitution of different stamps.

### Micro-Contact Printing Stamps

Methods of making micro-contact printing stamps are known in the art. For example, the inventors have previously described how to make a flexible micro-contact printing stamp or macro-stamp (i.e., a stamp comprising two or more smaller stamps with different patterns) in co-pending U.S. application Ser. No. 12/206,146 (U.S. Pub. App. No. U.S. 2009/0087019), which is incorporated herein by reference. Specifically, the flexible stamps of the present technology are preferably made by a molding process, wherein a master mold is provided having one or more patterns in opposite relief of the patterns intended for the flexible stamp.

Preferably, a stamp or macro-stamp is fabricated in at least two successive molding steps to form at least two layers—a first layer comprising a contact surface with one or more micro- or nano-structured patterns (preferably with no ferromagnetic particles), and a second layer comprising ferromagnetic particles. Such a multi-layer stamp or macro-stamp would also encompass, for example, a stamp having more than two layers having different amounts of ferromagnetic material, or a flexible stamp having varying amounts of ferromagnetic material throughout its thickness. However, the stamp may also be formed as a single layer comprising ferromagnetic particles.

In examples having at least two layers, a first molding step includes pouring a hardenable material into the mold to form a first elastomer layer having a surface with a micro- or nano-structured pattern (i.e., the intended contact surface of the stamp for depositing a substance onto a substrate in a pattern). This first elastomer layer is preferably made of one or more hardenable thermoplastic or elastomeric materials suitable for reproducing the pattern in the mold, such as for example, polydimethylsiloxane (PDMS), polymethylmethacrylate (PMMA), Kraton D (SBS), poly(butyl terephthalate-block-poly(tetramethylene glycol) (PBT-PTMG), photo-cured PDMS, Polyvinylpyrrolidone (PVP), Poly(ether sulfone) (PES), Polyetherimide (PEI), or agarose. Particularly preferable PDMS materials include, for example, Dow Corning Sylgard™ 182, 184, or 186. This first elastomer layer preferably does not include ferromagnetic material. This step of molding is followed by partial cross-linking of the layer, for example, by pre-curing at 60° C. for 15 min.

At least one additional layer is then formed on top of the first layer by pouring a hardenable material into the mold which includes premixed ferromagnetic material. Such a second elastomer layer can be made of the same hardenable thermoplastic or elastomeric material as the first elastomer layer, but may also be made with a different hardenable material. For example, PDMS may be used in the second layer, which the inventors have discovered is preferable for obtaining high density concentrations of soft ferromagnetic particles while also retaining desirable mechanical properties for use as a micro-contact printing flexible stamp. The two layers are then co-cured, for example at 110° C. overnight. The first partial cross-linking avoids any mixing between the two layers during the overmolding of the layer loaded with ferromagnetic particles while permitting the second layer to fix to the first layer during the subsequent co-curing step.

The ferromagnetic material used in the second layer may comprise, for example, any suitable ferromagnetic material that can be magnetized, such as ferrite particles (e.g., a ceramic comprising iron (III) oxide, manganese, and zinc), pure iron (optionally protected from oxidation), nickel, cobalt, iron-nickel-molybdenum alloys such as SuperMalloy®, iron-silicon, or alloys or combinations thereof, among others. The ferromagnetic material is preferably in the form of particles, powder, shavings, rods, strips, or beads. In certain embodiments, the ferromagnetic material can comprise nanoparticles smaller than about 200 μm. Alternatively, the ferromagnetic material can comprise a ferromagnetic foil, sheet, or layer that is positioned evenly in the second elastomer layer. Preferably, the ferromagnetic material is provided in the form of fine particles, powder, or the like so that the ferromagnetic material does not harm the polymerization of the stamp, and so that they remain in suspension and are uniformly distributed in the second elastomer layer. The ferromagnetic material preferably comprises between about 10% and between about 95% by weight of the second layer, more preferably between about 50% to about 95% by weight of the second layer, and most preferably between about 50% to about 80% by weight of the second layer. While not wanting to be bound by any particular theory, it is believed that if fine ferromagnetic particles, powders, or the like is used, a high concentration of ferromagnetic material may be provided without adversely affecting the flexibility of the stamp.

Additionally, it is preferable to use a “soft” ferromagnetic material in the present invention. By “soft” ferromagnetic material is meant a ferromagnetic material that can be magnetized but does not tend to stay magnetized when a magnetic field is removed. By using a soft ferromagnetic material, the second elastomer layer can be magnetized and de-magnetized, which is preferable so that the flexible stamp can be moved or manipulated.

The soft ferromagnetic particles in the second layer make the stamp sensitive to a magnetic field, such that the flexible stamp can be manipulated with a magnetic field. The presence of these particles also modifies, for example, the electric conductivity of the layer, reducing its electric resistance to some tens of thousands of ohms. Therefore, both of these properties can be modified by adjusting the amount of ferromagnetic material in the second elastomer layer of the stamp.

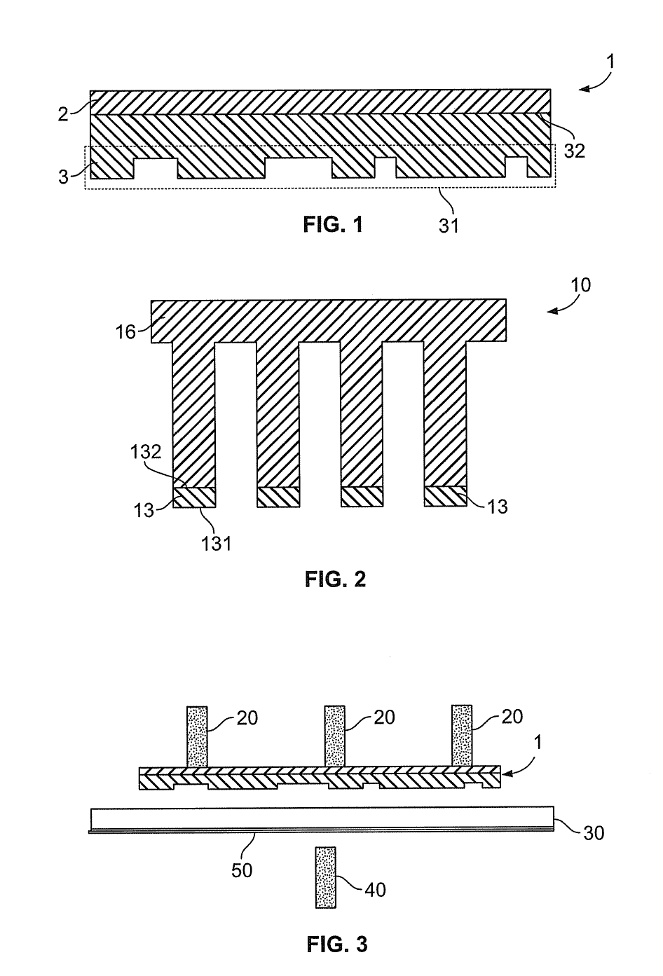

FIG. 1 illustrates an exemplary flexible stamp 1 made according to the present technology. A first elastomer layer 3 is preferably comprised of PDMS and includes a contact surface 31 capable of depositing a substance onto a substrate in a pattern and an opposing surface 32. A second elastomer layer 2 is provided that is fixed to the first elastomer layer 3 along the opposing surface 32. The second elastomer layer 2 is preferably comprised of PDMS containing soft ferromagnetic material.

FIG. 2 illustrates an exemplary flexible macro-stamp 10 made according to the present technology. The macro-stamp includes a plurality of stamps 13 comprising a first elastomer layer, wherein each of the stamps 13 comprise a contact surface 131 capable of depositing a substance onto a substrate in a pattern, and an opposing surface 132. A second elastomer layer 12 forms the body of the macro-stamp, and is fixed to the stamps 13 along their opposing surfaces 132. The stamps 13 comprising a first elastomer layer, and the second elastomer layer 12 forming the body of the macro-stamp, are both preferably made of PDMS. The second elastomer layer 12 forming the body of the macro-stamp preferably contains soft ferromagnetic material.

### Magnetic Manipulation of Stamps

One preferable use of a soft lithography stamp in the present technology is that the one or more layers containing ferromagnetic material provide a stamp that can be magnetically moved, positioned, or replaced. Therefore, an apparatus or process for soft lithography can be partially or fully automated. Therefore, certain embodiments relate to an apparatus for micro-contact printing that is at least partially automated, and to magnetic means for moving, positioning, or replacing a stamp.

For example, FIG. 3 illustrates some basic exemplary components of a micro-contact printing apparatus of the present technology. In particular, a stamp 1 is provided as shown in FIG. 1, having a first elastomer layer 3 with a contact surface 31, and a second elastomer layer 2 having ferromagnetic material. Alternatively, a macro-stamp 10 as disclosed in FIG. 2 can be used, or any other type of single or multi-layer stamp as discussed above can be used. One or more magnetic field generators 20 may be provided, preferably above the stamp 1 or micro-stamp 10. Additionally, one or more magnetic field generators 40 may be provided, preferably below a substrate 30 (such as a glass slide or silicon wafer). An electrode 50 may also be provided for measuring the capacitance between the stamp and the magnetic field generator 40.

The one or more magnetic field generators 20 are preferably electromagnets comprising wire coils, loops, or solenoids capable of producing a magnetic field. Exemplary electromagnets are available from Luxalp, Villaz, France, Binder Magnetic, Gennevilliers Cedex, France, or BMS Magnets. The magnetic field generators 20 may also alternatively be comprised of permanent magnets, or alternatively, permanent magnets surrounded by a wire coil, loop, or solenoid. In embodiments where a magnetic field generator 20 is comprised of an electromagnet, it produces a magnetic field when an electric current is applied to it. This magnetic field will magnetize the ferromagnetic particles in the stamp, and attract the stamp 1 or macro-stamp 10 towards the magnetic field generator 20 so that the stamp 1 or macro-stamp 10 will stick to the magnetic field generator 20.

By moving the magnetic field generator 20, therefore, the stamp 1 or macro-stamp 10 can then be moved. When the electric current applied to the one or more magnetic field generators 20 is turned off, the stamp 1 or macro-stamp 10 will no longer be attracted to the magnetic field generators 20 and will be released. A stamp 1 or macro-stamp 10 can moved, for example, from a holder or holding area to a substrate 30 (such as a glass slide or silicon wafer, as discussed in more detail below) for depositing a substance (also discussed in more detail below) from the stamp 1 or macro-stamp 10 to the substrate 30 via contact. Preferably, once a stamp 1 or macro-stamp 10 is moved onto a substrate 30, the one or more magnetic field generators 20 are de-activated, so that the magnetic field generators 20 do not continue to attract the stamp 1 or macro-stamp away from the substrate 30. Subsequently, one or more second magnetic field generators 40 may be activated (as discussed in more detail below) to provide substantially uniform pressure of the stamp 1 or macro-stamp 10 against the substrate 30 in order to deposit a substance onto the substrate.

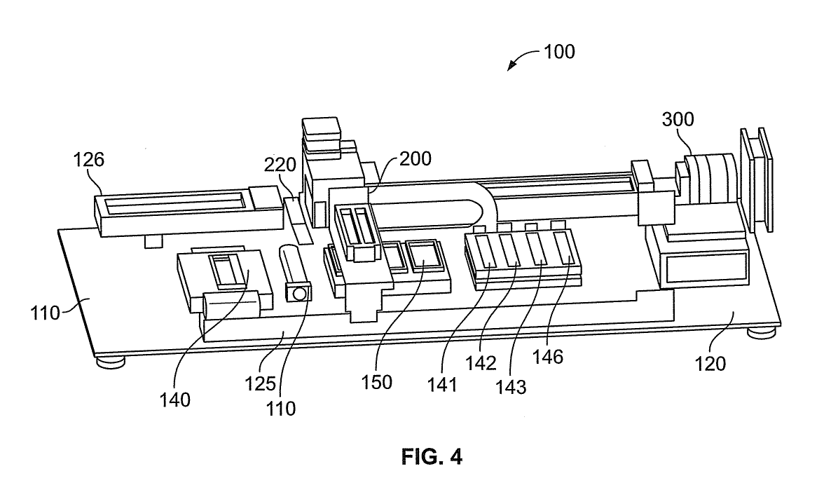

FIG. 4 illustrates a more detailed exemplary automatic soft lithography apparatus 100 according to the present technology. The exemplary apparatus includes a table 120, which includes tracks 125 and 126, which support a mast 200. The mast 200 is configured to move in translation relative to the table 120 along a longitudinal axis formed by guides 125 and 126, moved by motor 300. The mast 200 supports a magnetic field generator 220 for lifting, holding, or moving a stamp 1 or macro-stamp 10. The magnetic field generator 220 can therefore be moved longitudinally with the mast 200 relative to the table 120.

In exemplary embodiments, the table 120 can include different positions corresponding to various operations performed during micro-contact printing. For example, a first position 110 may be provided, corresponding to a storage zone for stamps 1 or macro-stamps 10. By using an apparatus with a magnetic field generator 220, it is possible to use different stamps that can be changed as part of an automated or partially automated process.

A second position 150 may be provided, comprising an inking zone. This position can include one more tanks containing substances, solutions, or molecules to be deposited on the substrate. One or more of the tanks can also include a cleaning solution for cleaning a stamp 1 or macro-stamp 10 after use. Exemplary cleaning solutions can include an organic solvent (such as acetone or ethanol), deionized water, or phosphate buffer saline compound.

A third position 140 may also be provided, comprising a deposit zone capable of receiving a substrate (such as a slide or silicon wafer). This position may include a second magnetic field generator positioned under the substrate for providing a uniform pressure of the stamp 1 or macro-stamp 10 against the surface of the substrate during micro-contact printing (as discussed in more detail below).

A fourth position 160 may be provided for drying the stamp or macro-stamp with a blower that blows, for example, air, carbon dioxide, nitrogen, or other gases.

One or more fifth positions 141, 142, 143, or 144 may be provided for storing other substrates intended to receive a deposited substance in a pattern.

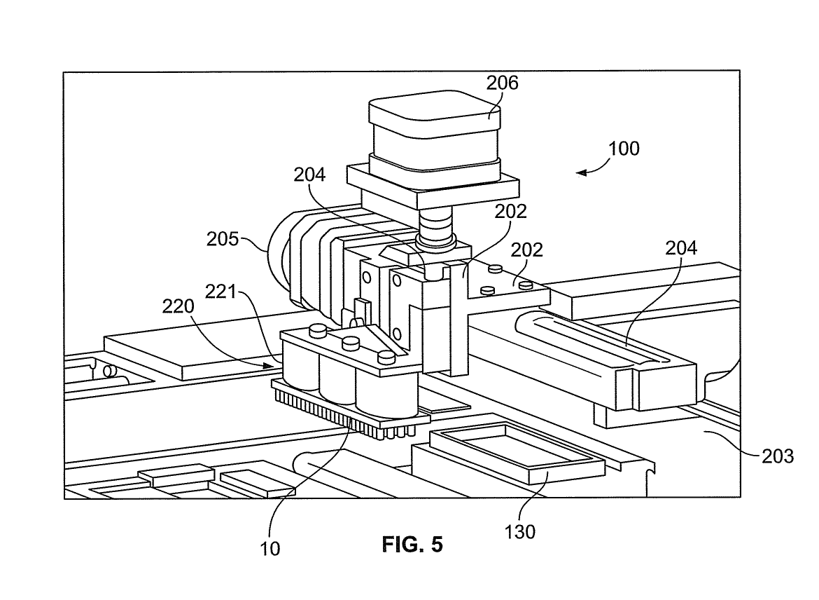

FIG. 5 further illustrates an exemplary automated or semi-automated soft lithography apparatus. For example, the mast 200 may include a cross piece 203, which rests on the tracks 125 and 126. The cross piece 203 supports an additional track 204. A motor 205 is provided which can move a transverse cart 202 parallel to the cross piece 203 (i.e., perpendicularly to the longitudinal direction of the table 120). The transverse cart 202 in turn supports vertical track 207 and motor 206, which can move a vertical cart 201 that holds the magnetic field generator 220. This configuration allows the magnetic field generator to be moved in any direction along three axes.

The magnetic field generator 220 may, for example, be comprised of multiple electromagnets, such as the three solenoids 221 shown in FIG. 5. When powered with an electric current, the magnetic field generator is capable of carrying a stamp 1 or macro-stamp 10 from one position in the apparatus to another.

Accordingly, the embodiments of FIGS. 4 and 5 can, for example, be used to move a stamp 1 or macro-stamp 10 from a storage zone 110, to an inking tank zone 150. Such an inking tank 150 can include, for example, a large tank, a small well, a microwell plate, or a convective assembly. At that point, the stamp 1 or macro-stamp is placed into an inking tank sufficient so that the stamp 1 or macro-stamp 10 retains at least some of the substance in the inking tank on the contact surface of the stamp 1 or macro-stamp 10. In certain embodiments, the magnetic field generator 220 may be used to oscillate the stamp 1 or macro-stamp 10 in the inking tank by modulating the power to the electromagnets in the magnetic field generator. This will enhance the uniformity of the inking. The stamp 1 or macro-stamp 10, held by the magnetic field generator 220, may then be brought above the drying zone 130. Next, the stamp 1 or macro-stamp 10 can be applied to one of the substrates in position 140. The stamp 1 or macro-stamp 10 can then be moved to a cleaning tank at position 150, or may be moved to storage area 110, where a different stamp or macro-stamp can be lifted, held, or moved and used in a subsequent micro-contact printing process.

### Magnetic Pressure Components

Another preferable feature of the present technology is a magnetic pressure component, whereby a second magnetic field generator is used to apply a substantially uniform pressure of a flexible micro-contact printing stamp against a substrate. This exemplary feature can provide pressure of the stamp against the substrate without the need for seals or vacuum. The magnetic pressure components can also be used in an automated or semi-automated micro-contact printing apparatus or process. For example, in an exemplary semi-automated system, magnetic stamp manipulation need not be employed, and stamps could be moved by hand, while the magnetic pressure component is used to ensure substantially uniform pressure. Such an embodiment could be very portable. Alternatively, a magnetic pressure component can be utilized in a more automated system such as that illustrated in FIGS. 4 and 5.

Referring again to FIG. 4, a magnetic field generator 40 is provided, preferably under the substrate (or on the side of the substrate opposite a stamp 1 or macro-stamp 10). The magnetic field generator 40 can provide a magnetic field that attracts the ferromagnetic particles in the stamp 1 or macro-stamp 10, tending to attract and flatten the stamp 1 or macro-stamp 10 towards the substrate 30, forcing the stamp 1 or macro-stamp 10 to conform to the surface of the substrate 30.

Preferably, the force pressing the stamp 1 or macro-stamp 10 against the substrate can be controlled, activated or de-activated, or varied. This is achieved, for example, by varying or eliminating the magnetic field applied by the magnetic field generator 40. For example, if the magnetic field generator 40 is a permanent magnet, the force pressing the stamp 1 or macro-stamp 10 against the substrate can be controlled, activated or de-activated, or varied by varying the distance of the magnetic field generator 40 from the substrate 30. Alternatively, the magnetic field generator 40 may be an electromagnet comprising a solenoid, and the flattening force can be controlled, activated or de-activated, or varied by varying or eliminating the current or voltage of the electric supply to the electromagnet. Further alternatively, the magnetic field generator 40 can be an electromagnet comprising a solenoid wound around a permanent magnet or ferromagnetic material, and the force pressing the stamp 1 or macro-stamp 10 against the substrate can be controlled, activated or de-activated, or varied by varying or eliminating the current or voltage of the electric supply to the electromagnet, or by varying the distance of the magnetic field generator 40 from the substrate.

### Identification and Adjustment of Optimal Stamp Contact Pressures

In exemplary embodiments comprising a magnetic field generator 40 for pressing a stamp 1 or macro-stamp 10 against a substrate, the optimal applied pressure can further be identified and adjusted. It has been discovered that the optimal stamp contact pressure for depositing a substance from the stamp 1 or macro-stamp 10 onto a substrate 30 is dependent on the effective surface area of contact between the stamp 1 or macro-stamp 10 and the substrate 30. Because the stamp 1 or macro-stamp 10 are preferably flexible and elastomeric, the surface area contacting the substrate will increase as the applied pressure is increased.

To estimate the effects of contact surface area, an electrode 50 may be placed between the magnetic field generator 40 and the substrate 30. A suitable electrode 50 is, for example, a Microchip PIC16F727 capacitance sensor. The layers 2 or 12 of the stamp 1 or macro-stamp 10 are electrically conductive because of the included ferromagnetic material the layer. The electrode 50 can be configured to measure the variation of capacitance between the stamp 1 or macro-stamp 10 and the substrate 30 due to the variation in air between them as the stamp 1 or macro-stamp 10 is pressed with varying force against the substrate 30. This quantity of air is proportional to the effective contact surface between the stamp 1 or macro-stamp 10 and the substrate 30. This measurement has the advantage of not being influenced by the magnetic field.

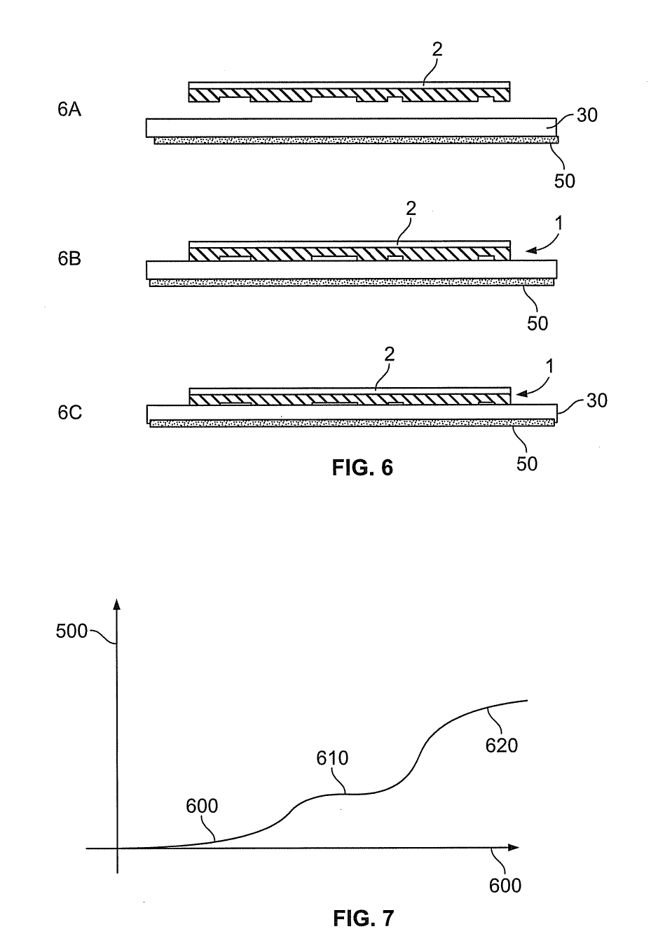

FIGS. 6A-6C illustrate such an embodiment. In each of the Figures, an electrode 50 is placed between the magnetic field generator 40 and the substrate 30, which comprise a capacitor with the second layer 2 or 12 of the stamp 1 or macro-stamp 10 and the air separating the two. By measuring the variation of this capacitor's capacitance, or the variation of capacitance in an electric circuit incorporating the capacitor, which is influenced by this thickness of the air layer, it is possible to obtain a signal characteristic of the force flattening the stamp 1 or macro-stamp 10 on the substrate 30.

FIG. 6A therefore shows a stamp 1 that is not in contact with the substrate, where the capacitance is low.

FIG. 6B shows a stamp 1 in decreasing distance from a substrate 30, where the capacitance has increased.

FIG. 6C shows that if the flattening force becomes too great, then the stamp 1 can be crushed, which will correspond to a significant increase of the capacitance of the capacitor, which will increases until a plateau corresponding to the complete crushing of the stamp 1 onto the substrate.

FIG. 7 is a graph showing the relationship of measured capacitance 500 as a function of the flattening force 400 of the stamp against the substrate. The capacitance reaches a first plateau 610 which corresponds experimentally to an optimal flattening force for the stamp 1 or macro-stamp 10 on the substrate 30. The second plateau 620 corresponds to when the stamp is crushed. Thus, by tracking the progression of the capacitance of the capacitor formed by the electrode 50 and the second layer, it is possible to adjust the magnetic field generator so as to obtain an optimal flattening force corresponding to the first plateau 610 in the measured progression of this capacitance.

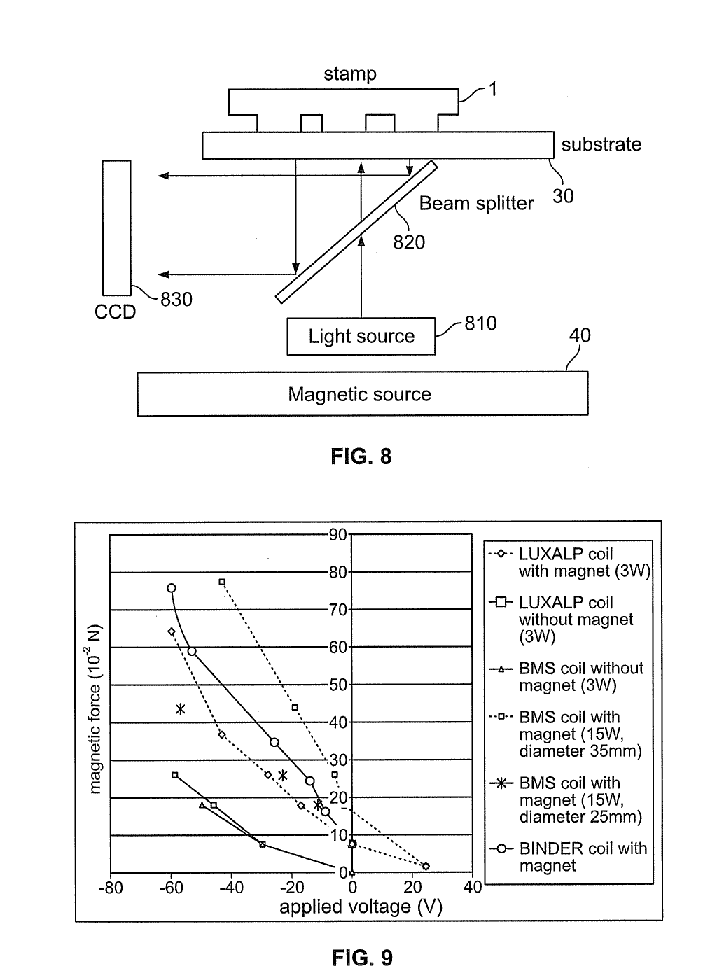

Alternatively, when a transparent substrate is used, the optimal applied pressure can be identified and adjusted photographically. FIG. 8 illustrates a schematic of an apparatus using a light source 810, a beam splitter 820, and a light sensor (such as a CCD camera) 830 placed between the magnetic field generator 40 and the substrate 30. The light source 810 illuminates the substrate 30 and stamp 1 or macro-stamp 10. Light is reflected back towards a beam splitter 820, and thereby to a light sensor 830. Where there is contact between the stamp 1 or macro-stamp 10 and the substrate, less light will be reflected and the light sensor 830 will provide an image of the contact between the stamp and the substrate. Therefore, the force applied to the stamp 1 or macro-stamp 10 can be increased until the optimum image is obtained in the light sensor 830.

FIG. 9 illustrates how magnetic force varies as applied voltage is varied in a given example. In this example, a PDMS magnetic stamp was used, which was a 30 mm diameter disk with a 2 mm thickness. The ferromagnetic layer of the stamp comprised 80% ferromagnetic powder by weight. Different magnets were used, including a Luxalp coil around a magnet (3 W), a Luxalp coil without a magnet (3 W), a BMS Magnets coil without a magnet (3 W), a BMS Magnets coil around a magnet (15 W, diameter 35 mm), a BMS Magnets coil around a magnet (15 W, diameter 25 mm), and a Binder coil around a magnet. As can be seen in the figure, each of the magnets exhibited drastically increasing magnetic force as applied negative voltage increased.

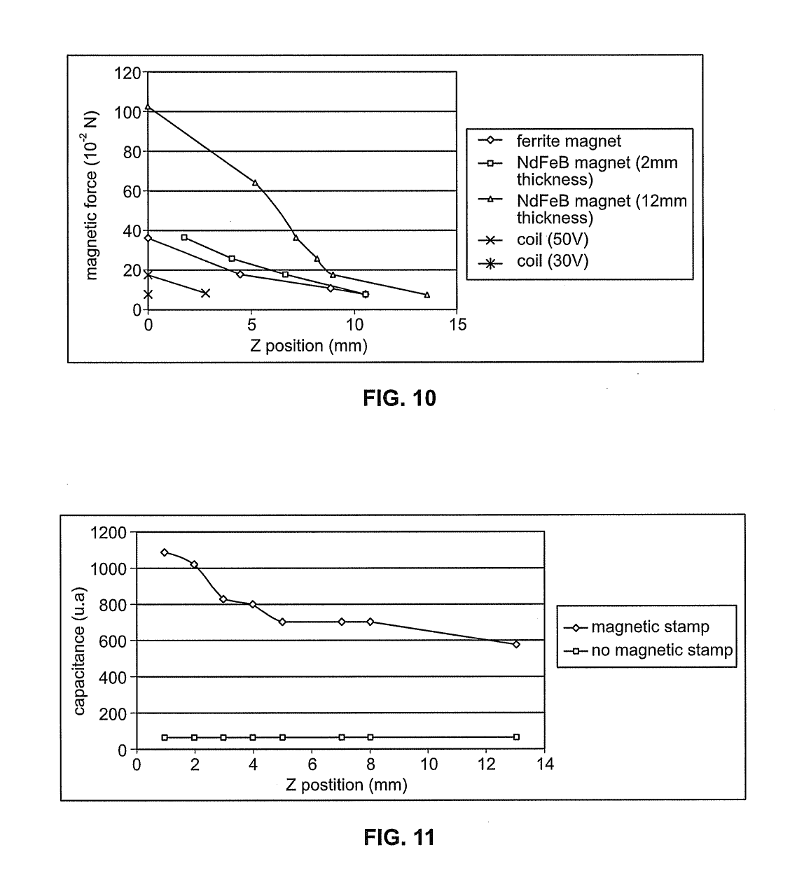

FIG. 10 illustrates varying magnetic force versus distance between an exemplary magnetic stamp and different exemplary magnetic field generators. The same PDMS magnetic stamp was used, having a 30 mm diameter and 2 mm thickness and a ferromagnetic layer comprising 80% ferromagnetic powder by weight. Different magnets were used, including a ferrite magnet, two NdFeB magnets (2 mm and 12 mm thickness) available from Calamit SRL, Milan, Italy, and two coils (with 50V and 30V electric voltage applied respectively). As can be seen, for each of the magnets, magnetic force decreased as the distance between the magnetic stamp and the magnet was increased.

FIG. 11 illustrates varying capacitance versus distance between an exemplary magnetic stamp and various exemplary magnetic field generators. The same PDMS magnetic stamp was used, having a 30 mm diameter and 2 mm thickness, and a ferromagnetic layer comprising 80% ferromagnetic powder by weight. An NdFeB magnet was used in this example, and a Microchip PIC16F727 capacitance sensor available from Microchip Technology, Inc., Chandler, Ariz. was used as the electrode. As can be seen, capacitance increased as the distance between the stamp and the magnetic field generator was decreased.

### Use of Micro-Contact Printing Stamps

The soft lithography micro-contact printing apparatuses and processes of the present invention can be used for a wide variety of applications. For example, the apparatuses and processes can be used to deposit a pattern of biological molecules (for example, proteins, nucleic acids, or lipids) on a substrate. They can also be used, for example, to prepare a biological material for microscopic analysis, or for preparing biochips, biosensors, cell cultures, lab-on-chips, or similar applications. One exemplary biochip is a PapilloCheck® (Greiner Bio-One®) for HPV detection. Other suitable uses include use in microfluidic systems, wherein chemical or biological molecules are deposited into a microfluidic system substrate (such as silicon with a patterned resist). Alternatively, the invention can be used to deposit, for example, an ink comprising nanowires, carbon nanotubes, or chemical molecules onto a silicon wafer, for applications such as MEMS/NEMS (Micro/Nano-Electro-Mechanical Systems). The invention can also be used for diagnostics with molecular imprinted polymers.

Varying substrates can therefore be utilized in the present invention, including glass (such as glass microscopic slides), plastic, hydrogel, silicon, paper, or any other suitable substrate that can accept a deposit of patterned substances.

Additionally, various substances and molecules may be deposited on a substrate using the present invention, including an aqueous solution with inorganic particles (such as SiO2, gold, iron, iron oxide, or aluminum oxide at a micro- or nanometer scale), chemicals (such as toxins or volatile organic compounds), biological agents (such as DNA, proteins, viruses, bacteria, yeast, or other compounds), or resist compounds.

The invention is now described in such full, clear, concise and exact terms as to enable any person skilled in the art to which it pertains, to practice the same. It is to be understood that the foregoing describes preferred embodiments and examples of the invention and that modifications may be made therein without departing from the spirit or scope of the invention as set forth in the claims.

We claim:

1. An apparatus for soft lithography comprising:
a flexible stamp having a contact surface capable of depositing a substance onto a substrate in a pattern, wherein
the flexible stamp contains at least one ferromagnetic material.

2. The apparatus of claim 1, wherein:
the contact surface is disposed on a first elastomer layer;
and a second elastomer layer is provided opposite the contact surface, wherein the second elastomer layer includes at least one dispersed soft ferromagnetic material.

3. The apparatus of claim 2, wherein the second elastomer layer comprises between about 50% to about 95% by weight of dispersed soft ferromagnetic material.

4. The apparatus of claim 2, wherein the first elastomer layer and second elastomer layer are comprised of polydimethylsiloxane (PDMS).

5. The apparatus of claim 2, further comprising a first magnetic field generator capable of moving and positioning the flexible stamp.

6. The apparatus of claim 5, wherein the first magnetic field generator comprises an electromagnet.

7. The apparatus of claim 6, wherein the first magnetic field generator is disposed on one or more tracks on which the first magnetic field generator can be moved.

8. The apparatus of claim 7, wherein the first magnetic field generator is disposed on three intersecting tracks so that the first magnetic field generator can be moved along three axes.

9. The apparatus of claim 8, further including an inking tank containing at least one substance to be deposited on the substrate, and one or more substrate holders.

10. The apparatus of claim 9, wherein the first magnetic field generator is capable of moving the flexible stamp along one or more of the three intersecting tracks, to move the flexible stamp between the inking tank and one or more substrate holders.

11. The apparatus of claim 2, further comprising a second magnetic field generator positioned below the substrate capable of applying pressure to the flexible stamp against the substrate.

12. The apparatus of claim 11, wherein the second magnetic field generator is controllable.

13. The apparatus of claim 12, wherein the second magnetic field generator is capable of being activated and de-activated to apply or remove the pressure to the flexible stamp against the substrate.

14. The apparatus of claim 12, wherein the second magnetic field generator is capable of being adjusted to vary the pressure to the flexible stamp against the substrate.

15. The apparatus of claim 14, further comprising an electrode between the second magnetic field generator and the substrate, wherein the apparatus is capable of measuring the electric capacitance between the electrode and the second elastomer layer of the flexible stamp.

16. The apparatus of claim 14, wherein the second magnetic field generator is a permanent magnet and the pressure to the stamp against the substrate is adjustable by varying the distance between the permanent magnet and the flexible stamp.

17. The apparatus of claim 14, wherein the second magnetic field generator comprises an electromagnet and the pressure to the flexible stamp against the substrate is adjustable by varying the current or voltage supplied to the electromagnet.

18. A micro-contact printing process comprising the steps of:
providing a flexible stamp having a contact surface with a pattern, wherein at least one layer of the flexible stamp contains ferromagnetic material,
exposing the contact surface of the flexible stamp with a substance so that at least some of the substance is retained on the contact surface,
disposing the contact surface of the flexible stamp against a substrate, and
applying a magnetic field on the opposite side of the substrate from the flexible stamp, such that the magnetic field applies a pressure to press the contact surface of the flexible stamp against the substrate, and at least some of the substance is transferred onto the substrate in the pattern.

19. The micro-contact printing process of claim 18, wherein the pressure applied by the magnetic field generator to press the stamp against the substrate is substantially uniform.

20. The micro-contact printing process of claim 18 further comprising:
providing an inking tank containing the substance,
moving the flexible stamp between the inking tank and the substrate by using a second magnetic field generator that is movable.
